(19) United States
(12) Patent Application Publication
(10) Pub. No.: US 2005/0091698 A1
(43) Pub. Date: Apr. 28, 2005

(54) Contents acquisition system

(75) Inventor: Yasushi Shikata, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/964,676

(22) Filed: Oct. 15, 2004

(30) Foreign Application Priority Data
Oct. 22, 2003 (JP) 2003-361742

(51) Int. Cl. H04N 7/173; H04N 7/00; H04N 7/16; H04N 5/91

(52) U.S. Cl. 725/132; 725/140; 725/152; 725/133; 348/552

(57) ABSTRACT

A contents acquisition system facilitating the downloading is disclosed. A digital TV set presents a scheduled time of acquisition of selected contents against the reservation of contents acquisition. With the arrival of the scheduled acquisition completion time, the TV set downloads the reserved contents out of the multiplexed broadcast data from a broadcast station. The TV set displays a list of the downloaded contents information, and selects the contents of which the printing is desired. The selected contents are output to the printer.

### BACKGROUND OF THE INVENTION

1. Field of the Invention

The present invention relates to a system for acquiring various contents selected while viewing a data broadcast program.

2. Related Background Art

In the digital broadcasting, a new data broadcast service is made possible in addition to the conventional broadcast services.

One feature of the data broadcast service is the interactivity. The audience can switch to his/her favorite screen by manipulating the focus on the screen using a remote controller while viewing the data broadcast program.

Another great feature of the data broadcast service is the possibility of handling the contents of various media. The conventional broadcasting can handle only dynamic images and sounds for the most part. In the data broadcasting, on the other hand, characters, patterns and still images can also be handled. An executable program such as a game program cannot yet be handled, but may be realized in the future.

Also, in the BS digital broadcasting, a rich screen presentation has been made possible by employing a strong layout description language for presenting the data broadcast screen.

Taking advantage of the interactivity and the features of the multimedia contents of the data broadcasting described above, various services are currently offered. By presenting the data interlocked with the specifics of a program to the audience, for example, the additional information are supplied to the audience. In addition, the on-line shopping and the on-line banking are realized.

Further, though not yet realized by the current BS digital broadcasting, the printing service using the data broadcasting is under study as one of the services to be provided in the future. The data broadcasting which uses a great number of still images and characters are suitable for printing, and there are many actual data broadcast programs which are desirably printed or used in prints. Maps, time tables, photos and other still images as well as the URL and text information such as detailed description may be the information of which printing is desired by the audience.

A data broadcast program intended to be printed may also be conceived. In a program to introduce a shop or a theme park, for example, the print data including the coupons, tickets, maps and prize catalogs for the shop or the theme park, as the case may be, may be transmitted by multiplexing on the broadcast data and printed out for the benefit of the audience wanting them.

These printing services are also useful as advertisements while the program is on air. The coupon service will enhance the interest on the part of the audience, and interested audience can be immediately supplied with more detailed information by printing out the commodity information.

To realize the printing in the data broadcasting, the extension of the broadcast standard is required. The print contents can be acquired by multiplexing on the broadcast data or by downloading from the Internet through a modem of the digital TV set. In the current BS digital broadcasting, the bit rate of the modem is low and the consistency with the Internet is unsatisfactory. Therefore, the latter method is practically difficult to employ. In the CS and more improved digital broadcasting, on the other hand, the modem speed is increased with a possibly higher consistency with the Internet, and therefore the latter method may be a practical choice.

In the method of multiplexing the print contents on the broadcast data, several formats of the print contents are now available. One is the use of the same BML (broadcast markup language) as the data broadcasting. The BML is an extension of XHTML1.0 (extensible HTML1.0) for broadcast applications. The use of BML facilitates the use of the monomedia contents such as the images and characters forming the data broadcast screen directly as print contents. As a style description of BML, CSS (cascading style sheets) extended for broadcast applications is employed. Under the circumstances, the use of BML for the format of the print contents requires the extension of CSS and BML elements and attributes. When the data broadcast contents are used for the print contents, both the audio-visual CSS and the printing CSS are required to be transmitted at the same time when transmitting the data broadcast data.

Also, in controlling the printing operation, the ECMAScript constituting the behavior description language of BML is required to be newly defined as a broadcast extension function. The broadcast extension functions requiring definition include a function to request from the digital TV set to the printer to start the printing operation and a function to make inquiry about the printing conditions.

An example of prompting the audience to print while the data broadcast program is on air is shown in FIGS. 3 and 4. In the case of FIG. 3, a print review of a coupon is presented on the TV screen, and when the audience selects a print button, the coupon is printed on the spot as long as the digital TV set is connected to the printer. In the example shown in FIG. 4, on the other hand, the audience is informed of only the availability of a print and the specifics of the print are not known before actual printing. Also in the example shown in FIG. 4, the pamphlet is printed on the spot when the audience selects the print button. Normally, the former method (FIG. 3) is used for tickets and coupons, while the latter method (FIG. 4) is applicable to the description of a commodity requiring detailed information. When the monomedia contents forming the data broadcast screen are used as print contents directly, the former method is desirably employed. In any case, in the two example methods shown above, the print contents are printed on the spot by selecting the print button.

The technique for multiplexing the print contents on the data being broadcast is described in Japanese Patent Application Laid-Open No. 11-234228.

Assume that the printing function of the data broadcasting is technologically established and the broadcast standard is defined. When the audience is prompted to print the print contents while the data broadcast program is on air as shown in FIG. 3 or 4, the current or the future CS digital broadcast system poses the following problem. First, it is difficult to transmit by multiplexing a large capacity of print contents while a program is being broadcast in a narrow band. Secondly, when a large capacity of the print contents are downloaded from the Internet, the line may be overcrowded depending on the degree to which the audience use the printing function. Also, the downloading time becomes irregular.

When the print contents are sent by being multiplexed on the broadcast data, the first problem described above is encountered. A simple coupon or text information may be printed without any problem. A large capacity of print contents including a plurality of sheets of data using many patterns and still images, however, is difficult to transmit while the program is being broadcast. The second problem described above is posed, on the other hand, when the print contents are downloaded through the Internet. When a multiplicity of audience request the downloading while the data broadcast program is on air, a great number of calls sent to the data center (broadcast station) at the same timing will easily cause the convergence. Even when the line connection is facilitated by use of the delayed call function, a great amount of irregular time may be required to download a large capacity of print contents from the broadcast station.

A probable solution to the aforementioned problems is to reserve the acquisition of the print contents in a data broadcast system. The above-mentioned problems are caused by the fact that the print contents are printed in real time during the broadcasting of a program. Nevertheless, some print contents are not required immediately while the program is viewed. The pamphlet of a commodity in which the audience is interested a little and a coupon of which the deadline is defined may be examples of such contents. The print contents of this type can be delivered to the audience accurately at the time designated by the broadcast station not during the broadcasting of the program. Once such a system is established, the problems described above can be avoided.

Specifically, even when the print contents are multiplexed on the broadcast data, the print contents are not transmitted simultaneously during the data broadcasting but in a time zone having a margin of frequency band. In this way, a large capacity of print contents can be positively delivered to the audience. When the print contents are downloaded through the Internet, on the other hand, the broadcast station is accessed by each digital TV set in a time zone different from the broadcast time (or the data broadcast event time) of the related data broadcast program. At the same time, the access point is spread for different digital TV sets. In this way, the line convergence can be avoided, and a large capacity of print contents can be positively delivered to the audience. Although this system is effectively applicable, there has so far been available no means that can realize it.

The objective of the present invention is to provide various contents acquisition systems for data broadcasting in which the acquisition of the accessorial contents such as the print contents introduced while viewing a data broadcast program can be reserved so that even a large capacity of accessorial contents of high image quality can be delivered positively to the audience.

### SUMMARY OF THE INVENTION

In order to achieve the objective as stated above, according to a first aspect of the invention, there is provided a contents acquisition system for acquiring two types of contents, i.e. the audio-visual and the accessorial contents which are transmitted in different time zones by being multiplexed on the broadcast data from the broadcast station. The contents acquisition system according to the first aspect comprises means for reserving the acquisition of the accessorial contents, means for downloading only the reserved accessorial contents among the multiplexed broadcast data at a scheduled transmission time, and means for transmitting the accessorial contents selected from the reserved accessorial contents to an external device.

A typical external device for this contents acquisition system is a printer, and the accessorial contents are the contents for printing. As an alternative, a memory card can be used as an external device with a music file as accessorial contents.

The contents acquisition system according to the first aspect of the present invention may further comprise means for presenting the scheduled time for complete acquisition of the reserved accessorial contents, means for presenting a list of the accessorial contents information downloaded, and means for selecting specified contents from the list.

According to a second aspect of the present invention, there is provided a contents acquisition system having the function of acquiring both the audio-visual contents transmitted by being multiplexed on the broadcast data and the accessorial contents transmitted through the Internet from a broadcast station. The contents acquisition system according to the second aspect of the present invention comprises means for reserving the acquisition of the accessorial contents, means for presenting the scheduled downloading time of the selected accessorial contents, means connected to the data center for acquiring the information on the access point holding the accessorial contents and the information on the time of accessing the accessorial contents, means adapted to be connected to the access point at the access time to download the selected accessorial contents, and means for transmitting the selected accessorial contents to an external device.

The contents acquisition system according to the second aspect of the present invention may further comprise means for presenting the scheduled downloading time of the reserved accessorial contents, and means connected to the data center for acquiring the information on the access point for holding the accessorial contents and the information on the time of accessing the accessorial contents. Also, like in the contents acquisition system according to the first aspect of the present invention, either the printer can be used as the external device with the print contents as the accessorial contents, or the memory card can be used as the external device with the music file as the accessorial contents.

Further, the contents acquisition system according to the second aspect of the present invention may comprise, like the system according to the first aspect, means for presenting the scheduled time of complete acquisition of the reserved accessorial contents, means for presenting a list of the accessorial contents downloaded, and means for selecting specific contents from the list.

From another point of view, this invention may be regarded to provide a contents acquisition method comprising the steps executed for processing a series of signals in the above-mentioned contents acquisition system. In this case, according to a first aspect of the present invention in this viewpoint, there is provided a contents acquisition method comprising the steps of acquiring the audio-visual contents transmitted from the broadcast station, reserving the acquisition of the accessorial contents related to the audio-visual contents transmitted from the broadcast station in a different time zone than the audio-visual contents, and downloading the reserved accessorial contents at the scheduled transmission time of the accessorial contents. According to a second aspect of the present invention in this viewpoint, there is provided a contents acquisition method comprising the steps of acquiring the audio-visual contents transmitted from the broadcast station, reserving the acquisition of the accessorial contents transmitted through the Internet related to the audio-visual contents, downloading the reserved accessorial contents by means connected to the access point of the accessorial contents at a different time than the receiving time of the audio-visual contents.

Further, this invention can be grasped also as a computer program executed for carrying out the contents acquisition method. In this case, according to a first aspect of the present invention in this viewpoint, there is provided a computer program for carrying out the contents acquisition method comprising the steps of acquiring audio-visual contents transmitted from the broadcast station, reserving the acquisition of accessorial contents related to the audio-visual contents transmitted from the broadcast station in a different time zone than the audio-visual contents, and downloading the reserved accessorial contents at the scheduled transmission time of the accessorial contents. According to a second aspect of the present invention in this viewpoint, there is provided a computer program for carrying out the contents acquisition method comprising the steps of acquiring the audio-visual contents transmitted from the broadcast station, reserving the acquisition of the accessorial contents transmitted through the Internet related to the audio-visual contents, downloading the reserved accessorial contents by means connected to the access point of the accessorial contents at a different time than the receiving time of the audio-visual contents.

According to this invention, various accessorial contents related to the audio-visual contents introduced during the data broadcasting can be reserved for acquisition, and the broadcast station can positively deliver a large capacity of print contents and music files high in image equality to the audience.

### BRIEF DESCRIPTION OF THE DRAWINGS

FIG. 1 is a block diagram showing a general configuration according to a first embodiment of the invention.

FIG. 2 is a block diagram showing a configuration of the digital TV set 20.

FIG. 3 shows an example of the data broadcast screen.

FIG. 4 shows an example of the data broadcast screen.

FIG. 5 is a flowchart showing the process of acquiring and printing the print contents according to a first embodiment.

FIG. 6 shows an example of the data broadcast screen.

FIG. 7 shows an example of the data broadcast screen.

FIG. 8 shows an example of the data broadcast screen.

FIG. 9 shows an example of the screen for presenting a list of print contents and operation thereof.

FIG. 10 is a flowchart showing the process of acquiring and printing the print contents according to a second embodiment of the invention.

### DETAILED DESCRIPTION OF THE PREFERRED EMBODIMENTS

Embodiments of the invention are explained in detail below with reference to the drawings.

(Embodiment 1)

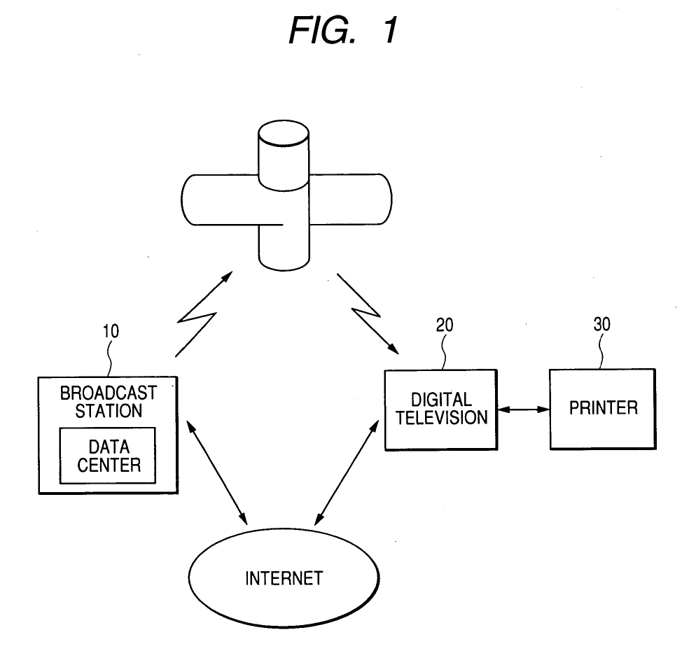

FIG. 1 is a block diagram showing a general configuration according to a first embodiment of the invention. According to this embodiment, a digital TV set 20 and a printer 30 are connected to each other directly or through a network in a manner capable of interactive communication. The digital TV set 20 is connected to a broadcast station 10 or specifically to a data center (hereinafter referred to collectively as the broadcast station 10) installed in the broadcast station 10 through the Internet. The digital TV set 20 can communicate with the broadcast station 10. Also, the digital TV set 20 can receive the digital broadcasting program transmitted from the broadcast station 10.

According to this embodiment, the digital broadcasting is conducted through a communication satellite or CATV. FIG. 1 shows an example of digital broadcasting through a communication satellite. The digital broadcasting includes the data broadcasting. The description format of the audio-visual contents of data broadcasting is assumed to be BML currently used for the BS digital data broadcasting. The digital broadcast data is transmitted by multiplexing the print contents used for the data broadcasting. The format for the print contents is assumed to include but not limited to the BML similar to the one used for audio-visual contents or an equivalent language.

The language equivalent to BML is a language (or a language system) capable of the structured presentation or style presentation of the data and having means of rebuilding such a data rewrite function. A markup language extended from XML (extensible Markup Language) like BML may be used as an example.

When the BML or a language equivalent to BML is used as a format of the print contents, the print contents may be sent as the same data as the data broadcast audio-visual contents. According to this embodiment, however, the audio-visual contents and the print contents are assumed to be sent as different data.

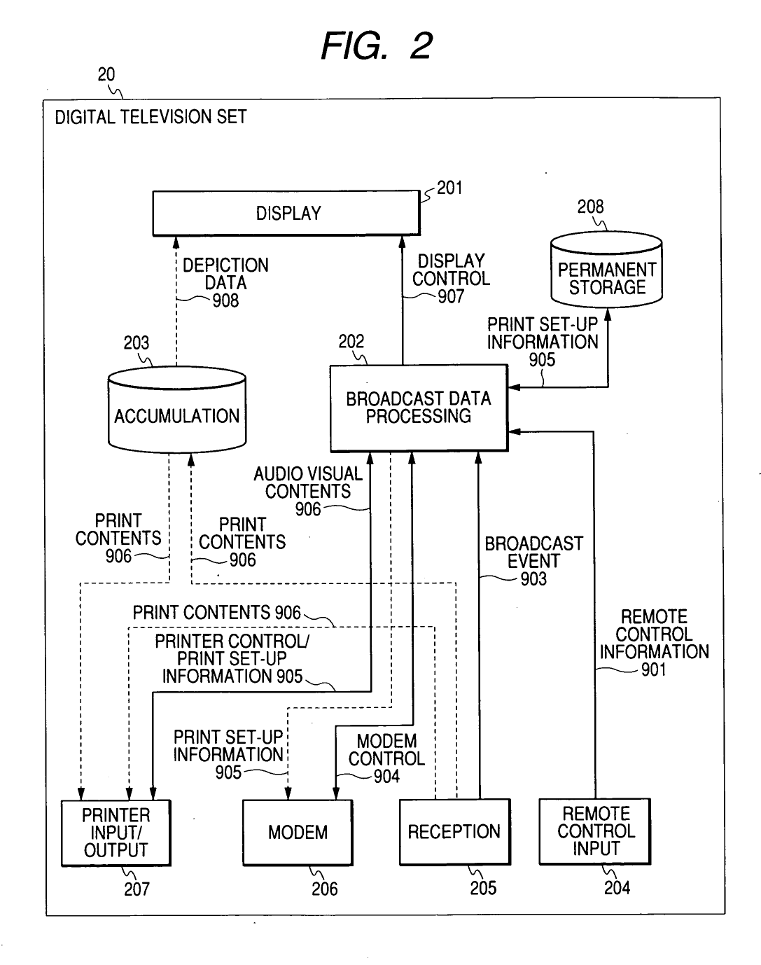

FIG. 2 is a block diagram showing a general configuration of the digital TV set 20. The solid lines between the modules in the set 20 indicate the control flow and the dashed lines the data flow.

Each module is explained. In the digital TV set 20, a receiving unit 205 receives the digital broadcast data transmitted from the broadcast station 10. The data broadcast audio-visual contents 902 (hereinafter referred to as the audio-visual contents 902) in the digital broadcast data are decoded by the receiving unit 205 and separated from the other data, after which the separated data is accumulated in an accumulation unit 203. In the normal data broadcast, the audio-visual contents 902 accumulated in the accumulation unit 203 are sent as depiction data 908 to the display unit 201 at appropriate time in compliance with an instruction of the broadcast data processing unit 202 and presented to the audience.

Upon depression of a remote control key by the audience while watching a data broadcast program, the remote control information 901 constituting the key information thereof are sent to the broadcast data processing unit 202 through a remote control input unit 204. The broadcast data processing unit 202, upon receipt of the remote control information 901, acquires the operation procedure corresponding to the remote control information 901 described in the audio-visual contents 902 stored in the accumulation unit 203, and executing the process in accordance with the described operation procedure, may send the display control information 907 to the display unit 201.

When the remote control information 901 is the one about the arrow key of the remote control for moving the focus on the screen, for example, the broadcast data processing unit 202 accesses the audio-visual contents 902 stored in the accumulation unit 203, and specifies the direction in which the focus is to be moved, while at the same time outputting the display control information 907 to the display unit 201 for focus movement. When any interrupt occurs during focus movement, the interrupt is executed. The remote controller described above, though not shown, has the function equivalent to those currently used for the BS digital broadcasting.

In similar fashion, when a broadcast event 903 is transmitted from the broadcast station 10 during the broadcasting of a data broadcast program, the particular broadcast event 903 is supplied to the broadcast data processing unit 202 through the receiving unit 205. The broadcast data processing unit 202, upon receipt of the broadcast event 903, acquires the operation procedure corresponding to the broadcast event 903 described in the audio-visual contents 902 stored in the accumulation unit 203, and executes the process in accordance with the operation procedure described. The broadcast even 903 is used, for example, as an end notice at the end of a program.

When the data broadcast program is intended for interactive communication with the broadcast station 10, on the other hand, the broadcast data processing unit 202 outputs the modem control information 904 to the modem 206 and gives an instruction for data transmission or connection with the broadcast station 10.

The digital TV set 20 has a permanent storage unit 208 as an area for storing the data in addition to the accumulation unit 203. The permanent storage unit 208 stores the data required for a predetermined length of time but no temporary data such as the audio-visual contents 902. Such data include the information for each audience such as the address of the audience.

When the data broadcast program permits printing, the contents stored in the accumulation unit 203 from the broadcast station 10 through the receiving unit 205 includes the print contents 906 in addition to the audio-visual contents 902. The print contents 906 are assumed to be transmitted by the same transmission method as but not limited to the one used for the audio-visual contents 902.

The print contents 906, depending on the form of the printing process of the data broadcast program, may be either accumulated in the accumulation unit 203 or transferred to the printer 30 through the digital TV set 20 without being accumulated in the accumulation unit 203. When the digital TV set 20 subjects the print contents 906 to the format processing or the image processing, the former case is involved. When the digital TV set 20 executes no process for the print contents 906, but all the format processing and the image processing are conducted by the printer 30, on the other hand, the latter case is involved. In the former case, the print contents 906 is subjected to the same receiving process as the audio-visual contents 902 in the digital TV set 20 and accumulated in the accumulation unit 203.

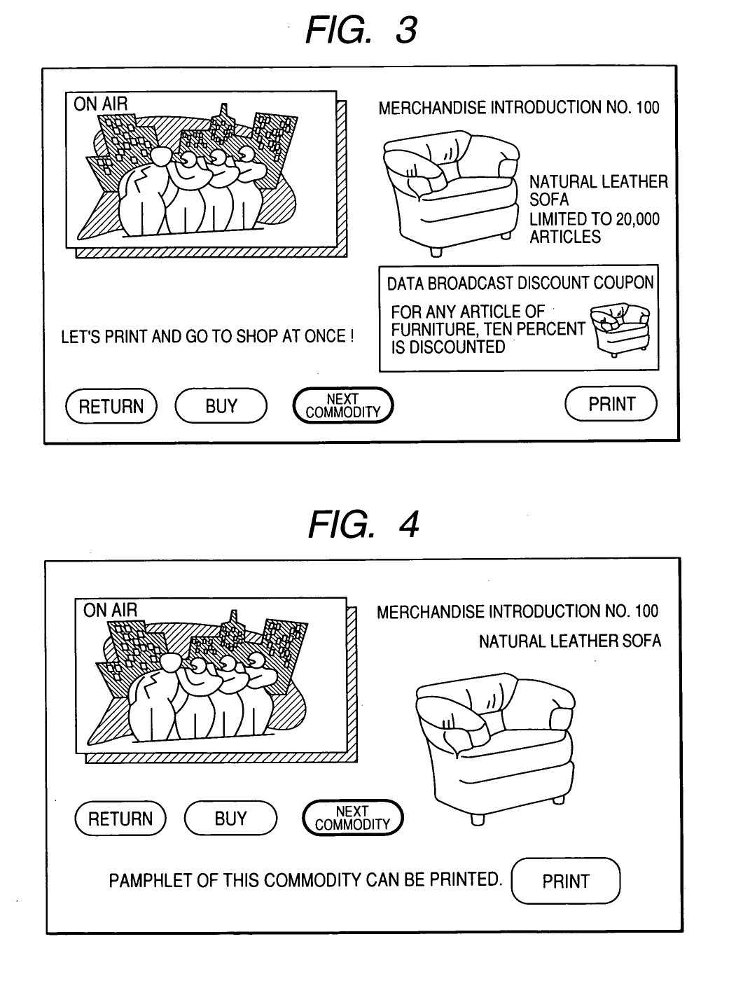

FIGS. 3 and 4 show an example of the screen for prompting the audience to print. These examples assume that the print contents concerning the data broadcast program being broadcast are transmitted while the program is on air. In this case, the print contents 906 are already accumulated in the accumulation unit 203 or can readily be received. The time of receiving and accumulating the print contents 906 depends on the specific description of the audio-visual contents 902.

Assume that the audience moves the focus to the print button and depresses the ENTRY key of the remote controller. The broadcast processing unit 202 receives the remote control information 901 (information on the ENTRY key in this case) from the remote control input unit 204. The operation associated with the depression of the ENTRY key when the focus is located on the print button is described in the audio-visual contents 902. The broadcast data processing unit 202 accesses the accumulation unit 203, and acquires and executes the operation steps corresponding to the remote control information 901 (information on the ENTRY key in this case).

When the audience selects the printing process, the broadcast data processing unit 202 sends the print contents 906 stored in the accumulation unit 203 to the printer 30 connected to the digital TV set 20 through the printer input/output unit 207. When the print contents 906 are not stored in the accumulation unit 203, the print contents 906 are received and sent to the printer 30 through the printer input/output unit 207 directly but not through the accumulation unit 203. The printer 30, upon complete receipt of the print contents 906, executes the printing operation. In the process, the broadcast data processing unit 202 transmits also the print set-up information 905 to the printer 30. This set-up information includes the number of sheets printed, the contents identification information and the identification information for identifying each print.

The printer 30 includes an interface unit (not shown) for receiving the print contents 906 and the printer control information 905 from the digital TV set 20. The interface unit can be used also for returning the result of printing to the digital TV set 20. When the printer 30 is connected directly to the digital TV set 20, the interface is a serial bus such as the USB (universal serial bus) or IEEE1394. The printer 30 includes a driver for actually printing the print contents 906 and an image processing means. The driver and the image processing means may alternatively be incorporated in the digital TV set 20, in which case the printer 30 is not required to include them.

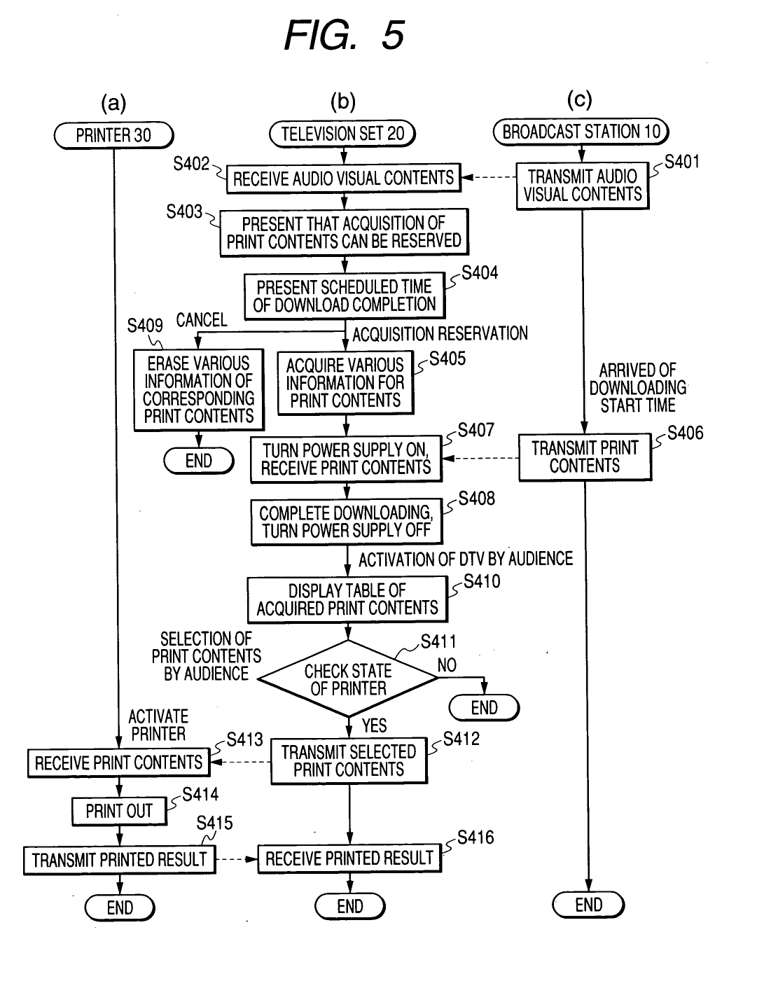

Next, an explanation is given about the process of acquiring and printing the print contents for the data broadcasting. FIG. 5 is a flowchart for these processes. (a) of FIG. 5 shows the process executed by the printer 30, (b) of FIG. 5 the process executed by the digital TV set 20, and (c) of FIG. 5 the process executed by the broadcast station 10.

The broadcast station 10 multiplexes the audio-visual contents 902 on the broadcast data and transmits them to the digital TV set 20 (step S401). The digital TV set 20, upon receipt of these data, decodes and separates the audio-visual contents and accumulates them in the accumulation unit 203 (step S402). The audio-visual contents 902 are described in BML, and the data structure in the accumulation unit 203 conforms with DOM (document object model). To acquire the information from the audio-visual contents, therefore, DOM API is used.

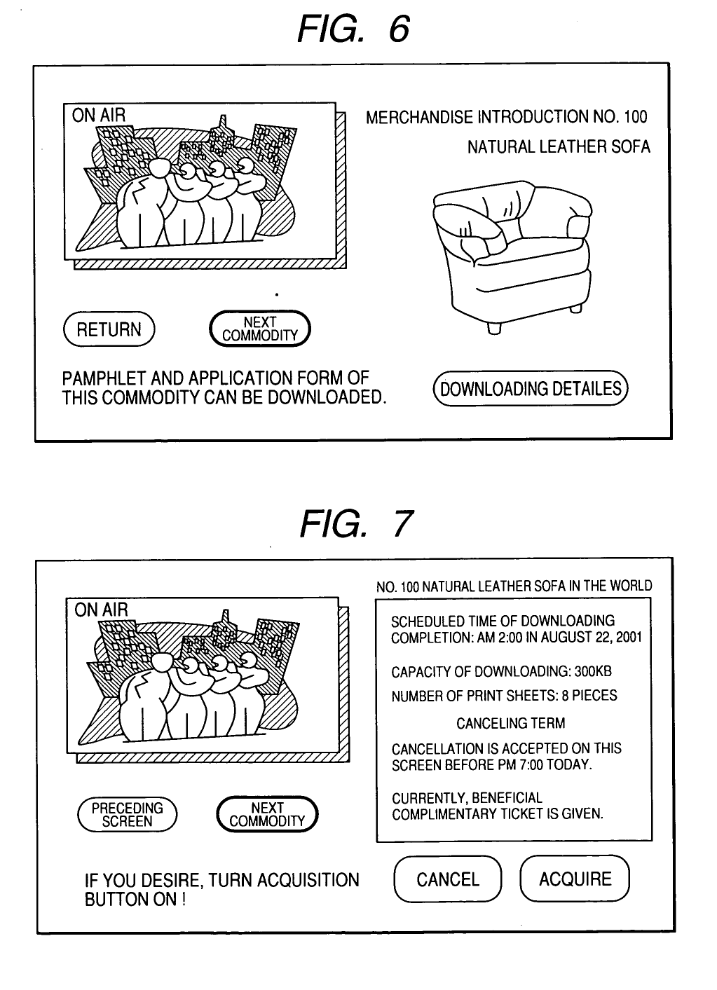

After the data are accumulated in the accumulation unit 203 in step S402, the digital TV set 20 presents the screen of the audio-visual contents 902 to the audience (step S403). The screen displayed in step S403 clearly indicates that the acquisition of the print contents constituting the accessorial contents is possible. If required, the scheduled day and time of complete acquisition of the print contents, the capacity, the number of sheets and features of the print contents are presented to the audience (step S404). An example is shown in FIGS. 6 and 7. FIG. 6 shows an example of the screen presenting the fact that the acquisition of the print contents 906 is possible. When the “DOWNLOADING DETAILS” button is selected, the screen shifts to the one shown in FIG. 7 to display the day and time of complete acquisition of the print contents 906 and the attribute information of the print contents 906.

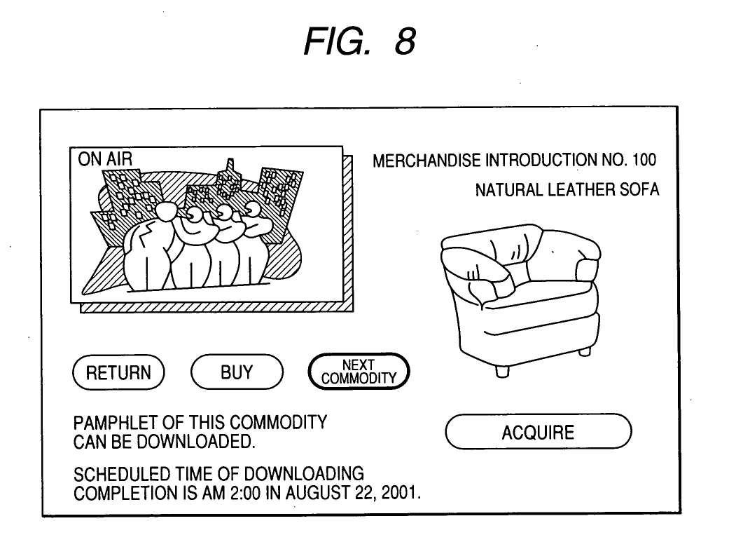

Also, as shown in FIG. 8, the audience may be prompted to acquire the print contents 906 on a simplified screen. In this case, the detailed information such as the day and time of complete acquisition and the number of sheets of the print contents 906 are not displayed.

With reference to the screen shown in FIGS. 6 and 7, the operation of this embodiment is explained. The addendum A contains a source list of examples of description in BML on the screen of FIG. 7. The line number is attached to the head of each phrase. Since the list is simplified, however, the style attribute of each element and the attribute such as “on focus” are not shown. Line 53 presents the ACQUIRE button in FIG. 7. Line 52 presents the CANCEL button in FIG. 7.

Upon selection of the ACQUIRE button in step S404, the event handler of the “onkeydown” attribute described in the “object” element on line 54 of the source list of the addendum A is executed. This event handler indicates the user definition function of ECMAScript described on lines 16 to 22 of the source list of the addendum A. Upon selection of the CANCEL button in step S404, on the other hand, the event handler of the “onkeydown” attribute described in the “object” element on line 53 of the source list of the addendum A is executed. This event handler indicates the user function of ECMAScript described on lines 7 to 14 of the source list of the addendum A. According to this embodiment, the acquisition reservation function for reserving the acquisition of the designated contents, the acquisition cancel function for canceling the reservation of acquisition of the designated contents and the investigation function for checking whether the designated contents have been reserved for acquisition or not are added as the broadcasting functions to ECMAScript of BML.

The process of steps S405 to S408 in FIG. 5 is the process for executing the acquisition reservation function. The acquisition reservation function is a function for reserving the downloading of various contents, and in the case under consideration, used for reserving the downloading of the print contents for the pamphlet shown in FIGS. 6 and 7. The PrintReserve ( ) function described in the event handler “P_Rec ( )” of the source list shown in the addendum A corresponds to the aforementioned acquisition reservation function.

Upon execution of the PrintReserve ( ) function, the digital TV set 20 executes the following process. First, the various information including the contents identification information, the contents type identification information, the information on the downloading channel, the time to start the downloading and the time-out period are stored in the permanent storage unit 208 (step S405). The contents identification information is the information unique to the contents itself. The contents type information is the information specifying the type of the contents which is the information indicating the print contents in the case under consideration. These information are delivered as an argument of the PrintReserve ( ) function.

Also, the current program name and time are stored in the permanent storage unit 208. These information are acquired from the SI information, etc. What information is acquired from the SI information depends on the type of the contents.

With the arrival of the download start time, the broadcast station 10 starts to download all the print contents 906 introduced in each program (step S406). The digital TV set 20 is automatically turned on with the arrival of the download start time in accordance with the information stored in the storage area in step S405, and in tune with the channel based on the designated channel information, starts receiving specific print contents 906 (step S407).

The broadcast station 10 may transmit also other contents than the print contents at the same time. The digital TV set 20, however, extracts only the print contents from the contents type identification information in store. The print contents 906 thus extracted are accumulated in the accumulation unit 203 or stored in an external storage device. The method of transmitting various contents may be varied with the contents type. Nevertheless, the digital TV set 20 has means for recognizing the transmission method for each contents type from the contents type identification information.

The data carrousel method identical with the audio-visual contents 902 may be used as a transmission method of the print contents 906. In the case of the data carrousel method, however, the same data are transmitted periodically, and therefore even in case of a download failure for some reason or other, the downloading can be advantageously repeated.

When the audience is viewing other channel at the scheduled time of contents transmission from the broadcast station and unable to receive a plurality of channels at the same time, the scheduled transmission time of the contents is required to be presented to the audience to permit the audience to determine whether the audience continues the current viewing or starts the downloading. When the current viewing is continued, the end of the viewing is awaited. The digital TV set 20 stands by until the time-out point extracted in step S405, and upon the lapse of this time-out point, the process of acquisition of the print contents 906 is ended. When the audience is not viewing at the end of downloading, the digital TV set 20 turns off the power supply as it is (step S408).

The operation of the acquisition cancel function is explained. The acquisition cancel function is the one for canceling the reservation of downloading various contents executed in step S405. In the data broadcast screen shown in FIG. 7, the cancel period is presented indicating that the reservation can be canceled on the data broadcast screen within that period.

Upon selection of the CANCEL button on the screen shown in FIG. 7, the event handler “P_Cancel ( )” of the “onkeydown” attribute described in the “object” element on line 53 of the source list shown in the addendum A is executed. The event handler “P_Cancel ( )” contains the description of the function PrintCancelReservation ( ) for canceling the download reservation. This function is executed and the download reservation is canceled. At the time of execution of the PrintCancelReservation ( ) function, the identification information of various contents canceled are delivered as an argument. When the print contents 906 already reserved for downloading have the corresponding identification information, the particular reservation is canceled. Then, in step S405, only the information on the corresponding print contents 906 is erased among the various information on the print contents 906 stored in the permanent storage unit 208 (step S409).

The investigation function is for checking whether the various contents designated are already reserved for downloading when executing the function ContentReserve ( ) to reserve the downloading in step S405 or when executing the function ContentCancelReservation ( ) for canceling the download reservation in step S409. An application of the function PrintIsReserved ( ) is shown in the event handler P_Cancel ( ) and the P_Rec ( ) of the addendum A. The identification information of the various contents are delivered as an argument.

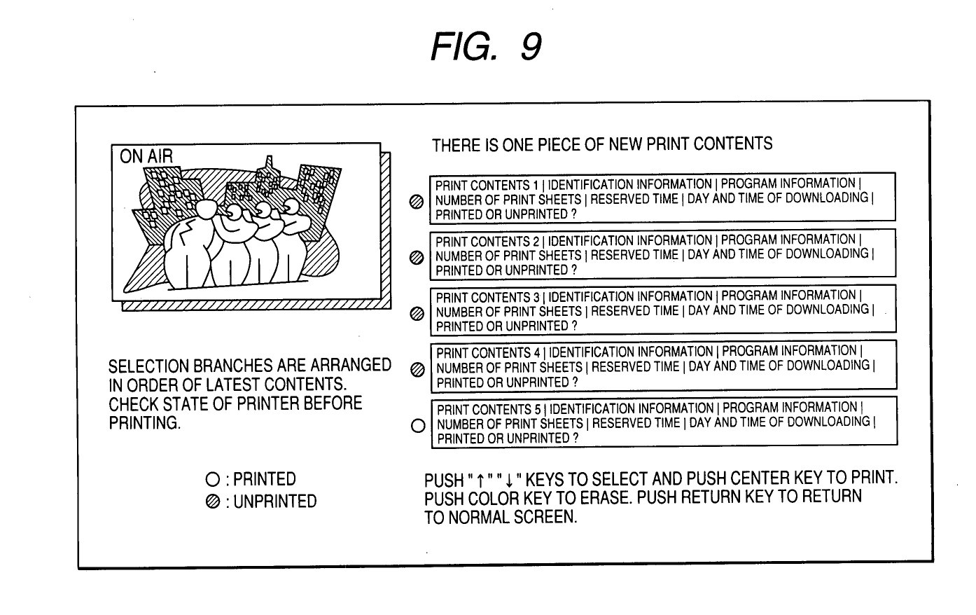

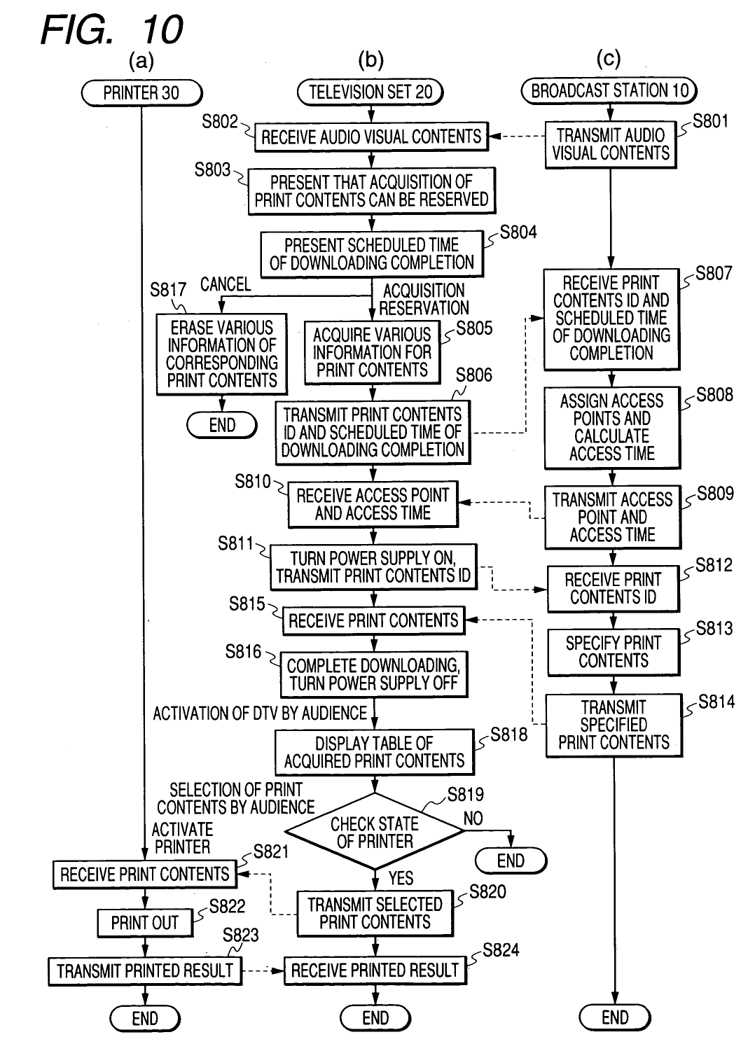

The process of step S408 and subsequent steps after acquisition of the print contents 906 from the broadcast station 10 is explained. Assume that the audience switches on the digital TV set 20 after acquisition of the print contents 906. When the new print contents 906 are stored in the accumulation unit 203 or other storage units, the digital TV set 20 notifies the fact to the audience (step S410). FIG. 9 shows an example. In addition to the new print contents 906, the old print contents thus far downloaded are also displayed at the same time. The related additional information are presented in each print contents 906. This additional information is the one stored in step S405.

The audience selects the contents desirably printed from the print contents 906. A selection method includes a method, in which like in the data broadcasting, the focus is moved by the remote controller and the ENTRY key is depressed. The function of presenting a list of the print contents 906 shown in FIG. 9 and selecting specific print contents 906 is unique to the digital TV set, and therefore the list may be displayed on the same screen as the EPG operation screen of the digital TV set 20.

The contents for other than the printing may also be downloaded by the download reservation process. In such a case, a list may be presented in which the particular contents are mixed with the print contents 906.

Once specific print contents 906 are selected, the digital TV set 20 confirms the state of the printer 30 (step S411). When the printer 30 is not connected or the power supply of the printer 30 is not switched on or otherwise the print operation is impossible, then the process is ended without proceeding to the subsequent steps. When the printer 30 is capable of print operation, on the other hand, the digital TV set 20 transmits the particular print contents 906, together with the print set-up information 905, to the printer 30 from the accumulation unit 203 or other external devices through the printer input/output unit 207 (step S412).

The print set-up information 905 contains the information on the number of sheets to be printed. The number of sheets to be printed is described in the audio-visual contents or determined using the remote controller on the screen by the audience. The print set-up information may contain the contents identification information specifying the print contents 906. The contents identification information is the information extracted in step S405.

The printer 30, upon receipt of the print contents 906 and the print set-up information 905 transmitted in step S412 (step S413), executes the printing process and prints out the required number of sheets (step S414). In the process, the contents identification information may be added to the prints.

The printer 30, upon completion of printing, transmits a completion notice to the digital TV set 20 (step S415). The digital TV set 20, upon receipt of the completion notice from the printer 30 and confirmation of the successful printing, ends the process (step S416).

According to this embodiment, when the print contents 906 are input by being multiplexed into the broadcast data, the function permitting the reservation of acquisition of the print contents 906 by the audience is defined in the audio-visual contents 902 constituting the data broadcast data, and means is included in the system in which the broadcast station 10 designates the downloading time of the print contents 906. In this way, the print contents 906 can be transmitted by the broadcast station 10 positively to the audience at an accurate time. Also, even the broadcast station 10 having only a small frequency band can transmit a large capacity of print contents upon designation of the transmission time of the print contents such as a midnight time zone when no other broadcasting is made. This is also beneficial to the audience since the acquisition time of the print contents becomes more clear, and therefore it is not necessary to wait before the digital TV set 20 until the end of the downloading each time the print contents 906 are acquired. As a result, the print service of the data broadcasting is expected to be more readily enjoyed.

(Embodiment 2)

A second embodiment of the invention is explained. The general configuration of this embodiment and the configuration of the digital TV set 20 and the printer 30 are similar to those in the first embodiment. Unlike in the first embodiment, however, the print contents 906 used for data broadcasting are not contained in the digital broadcast data. The digital TV set 20 acquires the print contents 906 from the Internet through the modem 206.

The process of acquiring the print contents and printing the print contents for the data broadcasting is explained. FIG. 10 is a flowchart showing the process of acquiring and printing the print contents. (a) of FIG. 10 shows the process executed by the printer 30, (b) of FIG. 10 the process executed by the digital TV set 20, and (c) of FIG. 10 the process executed by the broadcast station 10.

The process of steps S801 to S804 in FIG. 10 is substantially the same as the process of steps S401 to S404 in FIG. 5. Thus, the screen prompting the audience to reserve the acquisition of the print contents shown in FIG. 6, 7 or 8 before the end of step S804 is presented to the audience. Here, the operation is explained with reference to the example shown in FIGS. 6 and 7. The example of the description in BML on the screen shown in FIG. 7 is identical to the example shown in the addendum A, so that the ECMAScript of BML contains a new definition of the three functions including the acquisition reservation function, the acquisition cancellation function and the investigation function described in the first embodiment.

The process of executing the acquisition reservation function is explained. The process of steps S805 to S816 in FIG. 8 represents the process for executing the acquisition reservation function. Upon selection of the ACQUIRE button on the screen shown in FIG. 7, the PrintReserve ( ) function described in the “onkeydown” event handler P_Rec ( ) of the ACQUIRE button is executed (lines 16 to 22 in the addendum A). The PrintReserve ( ) function is the acquisition reservation function for reserving the downloading of the various contents. In the case under consideration, this function is used for reserving the downloading of the print contents 906.

Once the PrintReserve ( ) function is executed, the digital TV set 20 first stores, in the permanent storage unit 208, the contents identification information, the contents type identification information, the scheduled download completion time and the information for calling the data center (step S805). These information are delivered as an argument of the PrintReserve ( ) function. Also, if required, the current program name and time are also stored. These information are acquired from the SI information, etc. The difference from the first embodiment lies in that according to the second embodiment, the scheduled download completion time and the information for calling the data center are stored in the storage unit 208 at the time of execution of PrintReserve ( ) function. The data center manages the print contents 906 and, though not necessarily be the broadcast station 10, is regarded as the broadcast station 10 in the description that follows.

After that, using the information for calling the broadcast station 10, the digital TV set 20 accesses the broadcast station 10 while the program is being broadcast. Then, the contents identification information, the contents type identification information and the scheduled download completion time are transmitted (step S806). In the process, a delayed call is sent for each digital TV set 20 for connection to the broadcast station 10 in order to avoid convergence.

The broadcast station 10, upon receipt of these information (step S807), assigns or calculates the information on the access point holding the print contents 906, the access time to this access point and the time-out period (step S808) and returns them to the digital TV set 20 (step S809). The access point information is presented by telephone number of URI and prepared in a plurality of numbers.

The broadcast station 10, upon receipt of the download reservation from each digital TV set 20 in step S807, assigns the access point on first-come-first-served basis. Also, in order to observe the scheduled download completion time, the broadcast station 10 calculates the access time retroactively. The time-out period indicates the time limit within which the digital TV set 20 is required to make access by some means or other. When a given access point cannot meet the requirement, other access points are assigned.

The digital TV set 20, upon receipt of these information from the broadcast station 10 (step S810), stores them in the permanent storage unit 208.

With the arrival of this access time, the digital TV set 20 switches on the power supply and accesses the access point through the Internet from the modem 206 (step S811). Incidentally, in FIG. 10, this access point is described for access to the broadcast station 10. The access point, however, is not necessarily located in the broadcast station 10 like the data center. In the description that follows, however, the access point is assumed to be located in the broadcast station 10.

In step S811, the digital TV set 20 transmits the identification information of the print contents 906 to the broadcast station 10 having the aforementioned access point. The broadcast station 10, upon receipt of the identification information of the print contents 906 from the digital TV set 20 (step S812), selects specific print contents 906 from this identification information (step S813), and transmits the particular print contents 906 to the digital TV set 20 (step S814). The digital TV set 20, upon receipt of the print contents 906 transmitted from the broadcast station 10 in step S808 (step S815), switches off the power supply upon completion of the entire downloading.

The time at which the broadcast station 10 is accessed and the access point are varied from one digital TV set 20 to another. The series of process from steps S811 to S816, therefore, are not hampered by the use of the same channel by a multiplicity of digital TV sets. When the digital TV set 20 cannot be connected with the broadcast station 10 due to the disconnection between the modem 206 of the digital TV se 20 and an external device or for some other reasons or, if so connected, the print contents 906 cannot be downloaded, however, trials are repeated until the expiry of the time-out period and the process is terminated upon the expiry of the particular period.

The acquisition cancellation function is for canceling the reservation of the downloading of the print contents 906 to be executed in step S805. This is similar to the corresponding process in the first embodiment. Once the CANCEL button is selected on the screen shown in FIG. 7, the function PrintCancelReservation ( ) for canceling the download reservation described in the “onkeydown” event handler Print_Cancel( ) on line 53 of the source list of the addendum A is executed. Upon execution of this process, the identification information of the print contents 906 which is an argument is delivered, so that in the presence of the corresponding identification information in the print contents 906 of which the downloading is already reserved, the particular reservation is canceled. Upon cancellation of this reservation, only the information of the corresponding print contents 906 among the various information of the print contents 906 stored in the permanent storage unit 208 in step S805 is erased (step S817).

The operation of the investigation function according to this embodiment is the same as that of the investigation function according to the first embodiment, and therefore not described.

The process in and subsequent to step S816 after acquisition of the print contents 906 from the broadcast station 10 is similar to the corresponding process in and subsequent to step S410 in FIG. 5 according to the first embodiment.

When the audience turns on the digital TV set 20 after acquiring the print contents 906, the digital TV set 20 displays a list of new print contents 906 stored in the accumulation unit 203 or other storage device (step S818). FIG. 9 shows an example of display thereof. The audience selects new contents to be printed, from the list of the print contents 906 as shown in FIG. 9.

Once specific print contents 906 are selected, the digital TV set 20 confirms the state of the printer 30 (step S819). When the printing operation is impossible due to the disconnection of the printer 30 or power failure of the printer 30, the process is terminated without proceeding to the subsequent steps. When the printer 30 is capable of printing operation, on the other hand, the digital TV set 20 transmits the print contents 906 thereof from the accumulation unit 203 or an external storage device to the printer 30 through the printer input/output unit 207, together with the print set-up information 905 (step S820). The printer 30, upon receipt of the print contents 906 and the print set-up information 905 (step S821), executes the printing process thereby to print out the required number of sheets (step S822). In the process, the contents identification information may be added to the prints. The printer 30, upon completion of printing, transmits the print completion notice to the digital TV set 20 (step S823). The digital TV set 20 receives the print completion notice from the printer 30 and upon confirmation of successful completion of the printing job, terminates the process (step S824).

According to this embodiment, when the print contents 906 are downloaded through the Internet, the function is defined which makes possible the reservation of acquisition of the print contents 906 by the audience, and the digital TV set 20 includes means for enabling the broadcast station to designate the access point and the access time for acquiring the print contents 906. Therefore, the broadcast station 10 can positively transmit the print contents 906 to the audience. Also, when a multiplicity of audiences are involved, the access time zone is divided into the respective digital TV sets 20, and therefore a large capacity of print contents can be downloaded positively to the digital TV set 20 by efficient distribution of the access time.

The broadcast station 10, by receiving the download reservation from the digital TV set 20 through the Internet, can advantageously grasp the current utilization of the print contents 906 accurately. For the audience, on the other hand, the time of acquisition of the print contents 906 becomes more clear. Each time of acquisition of the print contents 906, therefore, the audience is not required to stand by before the digital TV set 20 until completion of downloading. As a result, like in the first embodiment, the print service of the data broadcasting can be received more easily.

In the first and second embodiments, only the print contents are shown as accessorial contents related to the audio-visual contents. This invention, however, is not limited to them, but is applicable also to a music file, a video stream or a game program with equal effect. Especially in the case of the music file, a memory card constitutes an external device to which the information are transmitted from the digital TV set. Also, the device connected to the digital TV set 20 is not limited to the printer 30. When a video stream is held, for example, an accumulator adapted to store the video stream may be connected. In similar fashion, when a game program is executed, a game replay device may be connected. Also, the external device may be integrally assembled with the digital TV set 20.

<Addendum A>

1:<?xml version=”1.0” encoding=”EUC-JP”?>
2:<!DOCTYPEbmlPUBLIC“+//ARIB STD-B24:1999//DTD BML
Document//JA””bml_1_0.dtd”
3:<?bml bml-version=”1.0”?>
4:<bml>
5:<head>
6:<script>
7:function P_Cancel ( )
8:{
9:...;
10:if(PrentIsReserved(“Identify print
contents”)!=”unreserved”){
11:PrintCancelReservation(“Print contents”);
12:}
13:...;
14:}
15:
16:function P_Rec ( )
17:{
18:...;
19:if(PrintIsReserved(“Identify print
contents”)!=”reserved”)2{
20:PrintReserve(“Identify print contents”, “print
contents acquisition start time”, ”time out”)
21:...;
22:}
23:
24:</script>
25:</head>
26:<body>
27:<div>
28:<object id=”Video stream” type=”video/X-arb-mpeg2”
data=” . . . .” remain=”remain” style=’ . . . .’/>
29:<object id=”Audio stream” type=”audio/X-atrib-
mpeg2-aac” data=” . . . .” streamstatus=”play”
remain=”remain”/>
30:</div>
31:<div id=” . . . .” style=’ . . . . ’>
32:<object id=”previous screen” type=“ . . . .”
data=” . . . .” onkeydown=” . . . .”/>
33:<object id=”next product” type=” . . . .”
data=” . . . .” onkeydown=”. . . .”·/>
34:</div>
35:<div>
36:<p>If you desire, turn on acquisition botton
ON!!</p>
37:</div>
38:<div>
39:<p>no.100 Natural leather sofa of the world</p>
40:</div>
41:<div>
42:<p>Scheduled download completion time</p>
43:<p>Aug. 22, 01, ‘2:00 a.m.</p>
44:<p>Download capacity</p>
45:<p>300KB</p>
46:<p>Number of sheets printed</p>
47:<p>Eight</p>
48:<p>Cancel period</p>
49:<p>Accepted on this screen until 7:00 p.m.
today?</p>
50:<p>Beneficial complementary ticket also
available!</p>
51:</div>
52:<div>
53:<object id=”Cancel” type=” . . . .” data=” . . . .”
onkeydown=”P_Cancel( );” style=’ . . . .’/>
54:<object id=”Acquisition” type=” . . . .” data=” . . . .”
onkeydown=”P_Rec( );” style=’ . . . .’/>
55:</div>
56:</body>
57:</bml>

This application claims priority from Japanese Patent Application No. 2003-361742 filed on Oct. 22, 2003, which is hereby incorporated by reference herein.

1. A contents acquisition system for acquiring contents transmitted from a broadcast station, wherein the contents include audio-visual contents and accessorial contents which are related to the audio-visual contents and transmitted during a different time zone than the audio-visual contents, the system comprising:
means for reserving the acquisition of the accessorial contents, and
means for downloading the reserved accessorial contents at a scheduled transmission time of the accessorial contents.

2. The contents acquisition system according to claim 1, further comprising means for transmitting the selected one of the reserved accessorial contents to an external device.

3. The contents acquisition system according to claim 1, wherein the external device is a printer and the accessorial contents are contents for printing.

4. The contents acquisition system according to claim 1, wherein the external device is a memory card and the accessorial contents are a music file.

5. A contents acquisition system for acquiring audio-visual contents transmitted from a broadcast station and accessorial contents which are related to the audio-visual contents and transmitted via a network, the system comprising:
means for reserving the acquisition of the accessorial contents, and
means adapted to be connected to an access point of the accessorial contents at a different time than the receiving time of the audio-visual contents for downloading the reserved accessorial contents.

6. The contents acquisition system according to claim 5, comprising:
means for presenting the scheduled downloading time of the reserved accessorial contents; and
means adapted to be connected to a data center for acquiring the information on the access point holding the accessorial contents, and the information on the time of accessing the access point.

7. The contents acquisition system according to claim 6, comprising means for transmitting the selected accessorial contents to the external device.

8. The contents acquisition system according to claim 5, wherein the external device is a printer and the accessorial contents are contents for printing.

9. The contents acquisition system according to claim 5, wherein the external device is a memory card and the accessorial contents are a music file.

10. The contents acquisition system according to claim 1, comprising:
means for presenting the scheduled time of complete acquisition of the reserved accessorial contents;
means for presenting a list of the downloaded accessorial contents information; and
means for selecting specific contents from the list.

11. The contents acquisition system according to claim 5, comprising:
means for presenting the scheduled time of complete acquisition of the reserved accessorial contents;
means for presenting a list of the downloaded accessorial contents information; and
means for selecting specific contents from the list.

12. A method for acquiring contents, the method comprising the steps of:
acquiring audio-visual contents transmitted from a broadcast station;
reserving the acquisition of accessorial contents related to the audio-visual contents the accessional contents being transmitted from the broadcast station during a time zone different than that for the audio-visual contents; and,
downloading the reserved accessorial contents at the scheduled transmission time of the accessorial contents.

13. A method for acquiring contents, the method comprising the steps of:
acquiring audio-visual contents transmitted from a broadcast station;
reserving the acquisition of accessorial contents related to the audio-visual contents, the accessional contents being transmitted via a network;
downloading the reserved accessorial contents through means connected to an access point of the accessorial contents at a time point different from the receiving time of the audio-visual contents.

14. A computer program for carrying out the contents acquisition method comprising the steps of:
acquiring audio-visual contents transmitted from a broadcast station;
reserving the acquisition of accessorial contents related to the audio-visual contents, the accessional contents being transmitted from the broadcast station during a time zone different from that for the audio-visual contents; and,
downloading the reserved accessorial contents at the scheduled transmission time of the accessorial contents.

15. A computer program for carrying out the contents acquisition method comprising the steps of:
acquiring audio-visual contents transmitted from a broadcast station;
reserving the acquisition of accessorial contents related to the audio-visual contents, the accessional contents being transmitted via a network;
downloading the reserved accessorial contents through means connected to an access point of the accessorial contents at a time point different from the receiving time of the audio-visual contents.
